(19) United States
(12) Patent Application Publication
(10) Pub. No.: US 2004/0129101 A1
(43) Pub. Date: Jul. 8, 2004

(54) Hypoid speed reducer and group of such devices

(75) Inventor: Yasushi Mineshima, Kurashiki-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, Ltd.

(21) Appl. No.: 10/740,533

(22) Filed: Dec. 22, 2003

(30) Foreign Application Priority Data
Dec. 20, 2002 (JP) 2002-370668

(51) Int. Cl. F16H 1/14

(52) U.S. Cl. 74/423; 74/421 R

(57) ABSTRACT

A hypoid speed reducer and a group of such devices capable of providing a high reduction ratio and still capable of reducing noise, lowering costs, enabling size reduction, and improving productivity. The hypoid speed reducer comprises a pinion shaft having a hypoid pinion formed thereon, and a hypoid gear set having a hypoid gear mating with the hypoid pinion. The hypoid speed reducer is constructed as a four-stage hypoid speed reducer having four gear sets including the hypoid gear set as the first-stage gear set, all of these gear sets being accommodated in a single gear box.

### BACKGROUND OF THE INVENTION

1. Field of the Invention

The present invention relates to a hypoid speed reducer and a group of such devices used in a conveyor or other such driven mechanism of a physical distribution system, and in particular to a hypoid speed reducer and a group of such devices that can provide a high reduction ratio and still are capable of reducing noise, lowering costs, enabling size reduction and improving the productivity.

2. Description of the Related Art

Conventionally, a hypoid speed reducer comprising a hypoid gear set having hypoid pinions and hypoid gears mating with the hypoid pinions is widely employed in various fields requiring a speed reducer that would allow for higher efficiency, lower noise, driven shafts with reduced axial dimension and so on. Various hypoid speed reducers have been proposed (see U.S. Pat. No. 5,375,479, for example).

These conventional hypoid speed reducers are adapted to realize reduction ratios of 5:1 to 240:1, that are possibly required by users, by means of a reduction gear mechanism in which one or two parallel gear set(s) is/are linked to a hypoid gear set.

Recently, however, a demand for higher reduction ratios exceeding 240:1 has arisen in the main application field, the field of transport and distribution equipment including conveyors or the like. In order to respond such demand, a hypoid speed reducer 505 as shown in FIG. 6 has been proposed, in which a high reduction ratio is realized by further adding a parallel gear set 504 to the input side of a known three-stage hypoid speed reducer 501 (i.e. between a motor 503 and the three-stage hypoid speed reducer 501).

However, with this conventional hypoid speed reducer 505 which has realized a high reduction ratio by adding the parallel gear set 504 to the input side of the three-stage hypoid speed reducer 501 (i.e. between the motor 503 and the three-stage hypoid speed reducer 501), it is difficult to realize reduction of noise, that is one of the merits expected for hypoid speed reducers. This is because when this hypoid speed reducer 505 is combined with the motor 503, the parallel gear set 504 that makes larger noise than the hypoid gear set when driven is disposed at the closest position to the motor 503 and is driven at a high speed.

For realizing noise reduction equivalent to the noise reduction afforded by hypoid gears, high precision tooth form correction, crowing, tooth flank grinding and so on are required for parallel gears 502 and 503, and hence the costs are increased and the productivity is lowered.

In addition, if the parallel gear set 504 is to be added, a gear box 506 or the like must be prepared to accommodate the parallel gear set 504, which will increase the number of components, leading to an increase of costs. Further, the dimension of the parallel gear set 504 is possibly increased in the radial direction of the axis, which will make it difficult to arrange the speed reducer especially when it is combined with the motor 503 to be used as a geared motor.

### SUMMARY OF THE INVENTION

Accordingly, the present invention has been made to solve these problems, and it is an object of the present invention to provide a hypoid speed reducer and a group of such devices capable of providing a high reduction ratio and still capable of reducing noise, lowering costs, being reduced in dimensions, and improving productivity.

The present invention solves the aforementioned problems by providing a hypoid speed reducer, comprising a hypoid gear set having a hypoid pinion and a hypoid gear, and a single gear box being able to accommodate four gear sets including the hypoid gear set, wherein three or four gear sets including the hypoid gear set as a first-stage gear set are accommodated in the single gear box.

According to the present invention, four gear sets including a hypoid gear set as the first-stage gear set are allowed to be accommodated in a single gear box, whereby it is made possible not only to obtain a high reduction ratio exceeding about 240:1 but also to lower the noise level of the entire hypoid speed reducer easily. In other words, if a typical hypoid speed reducer is combined with a driving device, the first-stage gear set will be driven at the highest speed among gear sets involved, and will tend to make noise during driving. However, the noise can be reduced by employing a hypoid gear set capable of reducing noise as the first-stage gear set. Further, in comparison with a conventional hypoid speed reducer which provides a high reduction ratio by adding a parallel gear set, the hypoid speed reducer according to the present invention can be manufactured at lower costs with higher productivity, can be reduced in dimensions, and can be installed simply.

One of the present invention, the four-stage hypoid speed reducer has a first intermediate shaft having the hypoid gear provided thereon, a second intermediate shaft linked to the first intermediate shaft via a second-stage gear set, and a third intermediate shaft linked to the second intermediate shaft via a third-stage gear set, wherein the second and third intermediate shafts are arranged in a same plane intersecting orthogonally with the center of a pinion shaft having the hypoid pinion formed thereon. Thus it is possible to reduce the size of the hypoid speed reducer, (particularly in the axial direction of the pinion shaft). Still further reduction in dimensions (particularly in the axial direction of the pinion shaft) can be achieved by arranging an output shaft of the four-stage hypoid speed reducer so as to be orthogonal to the center of the pinion shaft having the hypoid pinion formed thereon.

Additionally, according to the present invention, the hypoid speed reducer according to claim 1, wherein the hypoid speed reducer is constructed as a three-stage hypoid speed reducer having three gear sets in the single gear box, and three-stage speed reduction can be performed by the first-stage gear set, a middle-stage gear set, and a final-stage gear set, and wherein the middle-stage gear set comprise a pinion of a second-stage gear set of a four stage speed reducer, and a gear of a third-stage gear set of the four stage speed reducer. A user is thus allowed to select three-stage or four-stage reduction according to his/her intended use. Furthermore, it is also easy to change over from three-stage reduction to four-stage reduction or vice versa since the members such as the gear box can be used in common between the four-stage and three-stage reduction modes.

Many other merits can be obtained by providing the hypoid speed reducer according to the present invention as a component of a group described below.

For example, in a group of hypoid speed reducers, comprising the four-stage hypoid speed reducer as described above, and a two-stage or three-stage hypoid speed reducer having a hypoid gear set and one or two parallel gear set(s) linked to the hypoid gear set, wherein the four-stage hypoid speed reducer has identical dimensions of connection with a driven device to those of the two-stage or three-stage hypoid speed reducer. In this manner, it is made possible to provide a wide variety of reduction ratios possibly required by a user, and also the respective speed reducers having the same dimensions of connection can be applied to a driven device easily.

Further, in a group of hypoid speed reducers, comprising the four-stage hypoid speed reducer as described above, and a two-stage or three-stage hypoid speed reducer having a hypoid gear set and one or two parallel gear set(s) linked to the hypoid gear set, wherein each of the hypoid speed reducers constituting the group has at least a part of the gear sets or rotating shafts thereof used in common with another hypoid speed reducer in the group. In this manner, the component devices of the group are allowed to share members constituting the speed reducers. For example, the hypoid speed reducers may use in common with the final-stage gear set and the rotating shaft on which a pinion or gear constituting the final-stage gear set is provided. As a result, the costs of the hypoid speed reducers can be lowered and the development period can be shortened.

The same effects also can be obtained if, in a group of hypoid speed reducers, comprising the four-stage hypoid speed reducer as described above, and a three-stage hypoid speed reducer with a frame number one size smaller than the four-stage hypoid speed reducer when magnitude of torque handled by each speed reducer is defined by a frame number, wherein the hypoid gear set, a second-stage gear set linked to the hypoid gear set and a rotating shaft having a gear of the hypoid gear set and a pinion of the second-stage gear set formed thereon of the four-stage hypoid speed reducer are used in common by the three-stage hypoid speed reducer respectively as a hypoid gear set, a second-stage gear set linked to the hypoid gear set, and a rotating shaft having a gear of the hypoid gear set and a pinion of the second-stage gear set formed thereon.

### BRIEF DESCRIPTION OF THE DRAWINGS

FIG. 1 is a sectional view of a hypoid geared motor in which a motor is integrated with a hypoid speed reducer according to an embodiment of the invention, as viewed from the front of the output shaft of the hypoid geared motor;

FIG. 2 is an exploded plane cross section of the gear train of the hypoid speed reducer of FIG. 1;

FIGS. 3A, 3B and 3C respectively show a four-stage hypoid speed reducer, a three-stage hypoid speed reducer with a frame number one size smaller, and two-stage hypoid speed reducer;

FIG. 4 shows a hypoid geared motor in which a motor is integrated with a hypoid speed reducer according to an embodiment of the present invention allowing for speed reduction in three stages;

FIG. 5 shows a hypoid geared motor in which a motor is integrated with a hypoid speed reducer according to another embodiment of the present invention; and

FIG. 6 shows a conventional hypoid speed reducer.

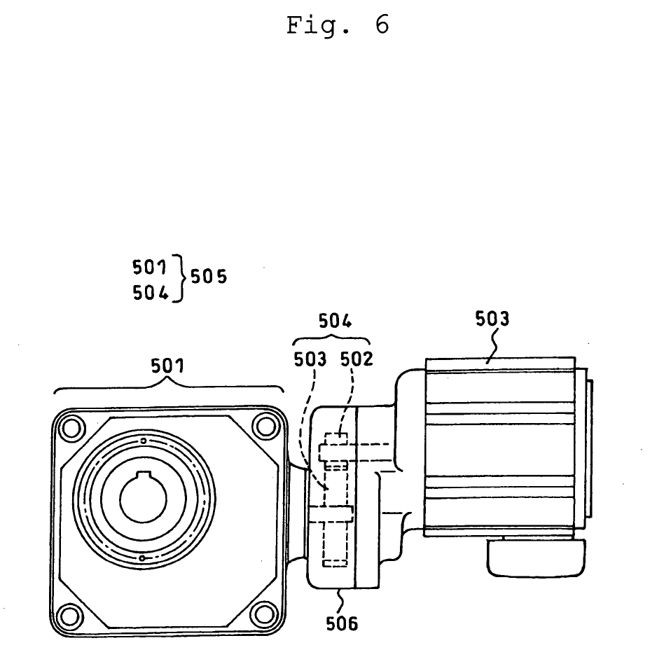

### DETAILED DESCRIPTION OF THE PREFERRED EMBODIMENTS

An embodiment of the invention will now be described by way of example and with reference to the accompanying drawings.

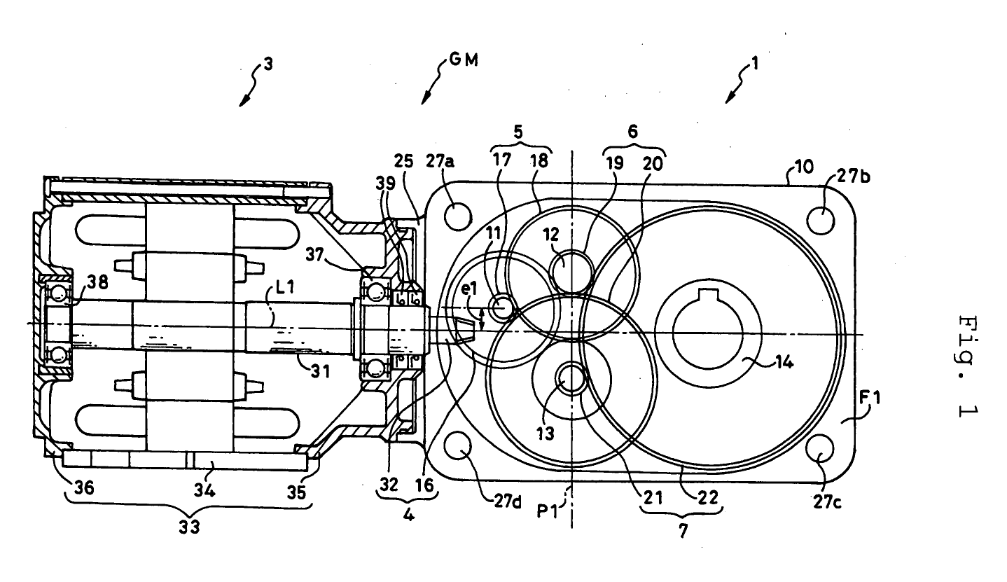

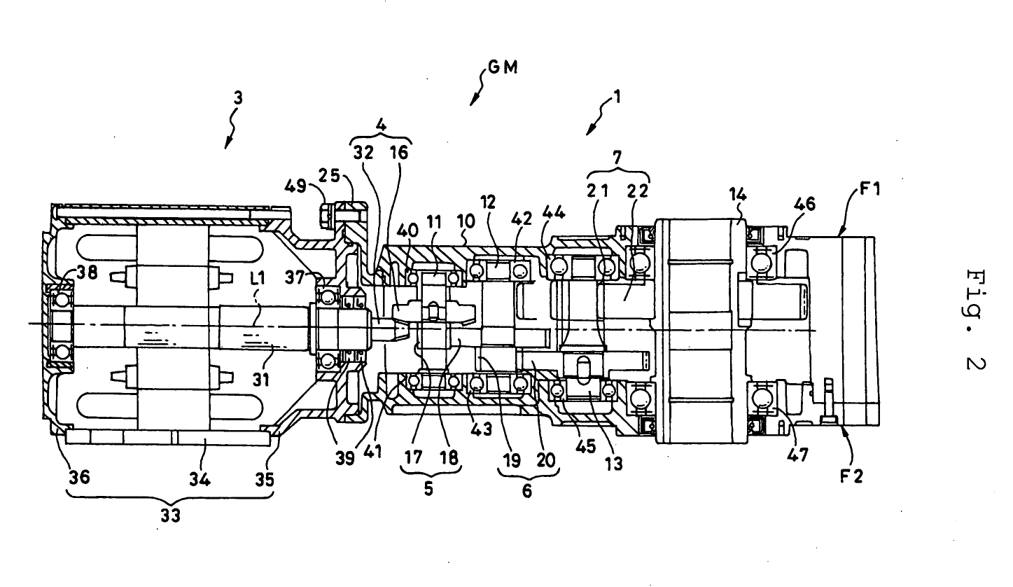

FIG. 1 is a sectional view of a hypoid geared motor GM having a motor (driving unit) integrated with a hypoid speed reducer according to the embodiment of the invention, as viewed from the front of the output shaft of the hypoid geared motor GM. FIG. 2 is an exploded plane cross section of the gear train of the speed reducer.

In FIGS. 1 and 2, the reference numerals 1 and 3 denote a four-stage hypoid speed reducer and a motor, respectively.

The hypoid speed reducer 1 comprises four gear sets comprising a hypoid gear set 4 and first to third parallel gear sets 5 through 7 (to be described later) and a single gear box 10 optimally designed to be large enough to accommodate the four gear sets 4 through 7. In the gear box 10, first to third intermediate shafts 11 through 13 and an output shaft 14 are arranged to be parallel to each other with a predetermined distance therebetween, and are rotatably supported by means of bearings 40 through 47.

As shown in FIG. 1, the second and third intermediate shafts 12 and 13 are located on a plane P1 that is orthogonal to the center L1 of a motor shaft (pinion shaft) 31 on which a hypoid pinion 32 is formed. The output shaft 14 is constituted by a hollow shaft passing through the gear box 10 and is disposed at the farthest position from the motor 3 so as to be orthogonal to the center L1 of the motor shaft 31. The reason why a hollow shaft is used as the output shaft 14 is because the hypoid speed reducer 1 can be connected to a counterpart device (driven device) at either left or right side. Of course, a solid shaft may be used instead of a. hollow shaft.

The motor 3 is connected to a side (left side in the drawings) of the gear box 10 such that the motor shaft 31 is orthogonal to the first intermediate shaft 11. The motor 3 has a motor casing 33 as an outer shell, and the motor casing 33 is composed of a tubular motor frame 34, a front motor cover 35 for closing the front opening of the motor frame, and a rear motor cover 36 for closing the rear opening. The motor shaft 31 is rotatably supported by a front bearing 37 fitted in the front motor cover 35 and a rear bearing 38 fitted in the rear motor cover 36. A couple of seals 39 are provided in front of the front bearing 37 fitted in the front motor cover 35 for preventing lubricating oil from penetrating into the motor 3 from the hypoid speed reducer 1.

The connection between the hypoid speed reducer 1 and the motor 3 is carried out by joining the front motor cover 35 to a side flange 25 of the gear box 10 by means of a bolt 49.

As mentioned above, the hypoid geared motor GM can be connected to a counterpart device (driven device) at either left or right side. The gear box 10 of the hypoid speed reducer 1 is provided with mounting faces F1 and F2 for mounting a driven device, each of these mounting faces being provided with four mounting bolt holes 27a through 27d. These mounting bolt holes 27a through 27d are formed in the vicinity of respective four corners of the mounting face F1 (F2) of the gear box 10 so as to pass through the gear box 10 in parallel with the output shaft 14. The connecting dimensions of the mounting face F1 (F2) are designed to be identical to the dimensions of connection with driven device of a two-stage or three-stage hypoid speed reducer, which is prepared as a component of a group of hypoid speed reducers. More specifically, the mounting face F1 (F2) of the four-stage hypoid speed reducer 1 and the mounting face of the two-stage or three-stage hypoid speed reducer are of a substantially similar rectangular shape, and the mounting bolt holes are formed in the same positions in the respective mounting faces, namely near the four corners of the rectangles.

Next, four gear sets accommodated in the hypoid speed reducer 1 according to an embodiment of the invention will be described.

The motor shaft 31 of the motor 3 serves as an input shaft of the hypoid speed reducer 1 and is provided with a hypoid pinion 32 at the tip end thereof. The hypoid pinion 32 is offset from the first intermediate shaft 11 by a distance e1 in the state where the motor 3 and the hypoid speed reducer 1 are connected together, and is engaged with a hypoid gear 16 mounted on the first intermediate shaft 11 within the gear box 10. This combination of the hypoid pinion 32 and the hypoid gear 16 constitutes a hypoid gear set 4 as the first-stage gear set.

The first and second intermediate shafts 11 and 12 are respectively provided with spur gears 17 and 18 mating with each other and constituting a first parallel gear set 5 as the second-stage gear set, within the gear box 10. Similarly, the second and third intermediate shafts 12 and 13 are respectively provided with spur gears 19 and 20 mating with each other and constituting a second parallel gear set 6 as the third-stage gear set. The third intermediate shaft 13 and the output shaft 14 are respectively provided with spur gears 21 and 22 mating with each other and constituting a third parallel gear set 7 as the final-stage gear set.

Torque inputted through the motor shaft 31 is transmitted to the hypoid gear set 4 comprising the hypoid pinion 32 and the hypoid gear 16, then to the first parallel gear set 5 comprising the spur gears 17 and 18, then to the second parallel gear set 6 comprising the spur gears 19 and 20, then to the third parallel gear set 7 comprising the spur gears 21 and 22, while being reduced in these four stages, and finally transmitted to the output shaft 14.

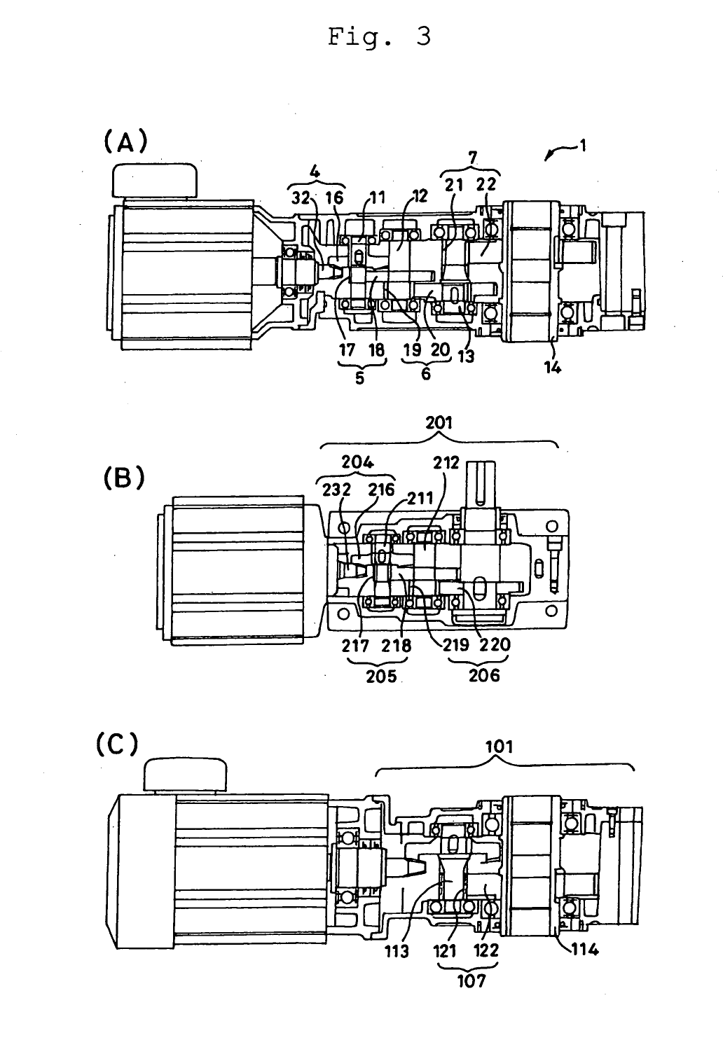

As shown in FIG. 3, the third parallel gear set (final-stage gear set) 7, the third intermediate shaft (rotating shaft) 13 on which the spur gear (pinion) 21 and spur gear 22 constituting the third parallel gear set 7 are provided, and the output shaft (rotating shaft) 14 of the hypoid speed reducer 1 (FIG. 3A) are used in common in a two-stage hypoid speed reducer 101 as shown in FIG. 3C as a final-stage gear set 107, an intermediate shaft (rotating shaft) 113 on which a spur gear (pinion) 121 and a spur gear 122 constituting the final-stage gear set 107 are provided, and an output shaft (rotating shaft) 114.

Further, the hypoid gear set 4, the first parallel gear set (second-stage gear set) 5 connected to the hypoid gear set 4, and the first intermediate shaft (rotating shaft) 11 on which the spur gear 16 of the hypoid gear set 4 and the spur gear (pinion) 17 of the first parallel gear set 5 of the hypoid speed reducer 1 are provided are also used in common in a three-stage hypoid speed reducer 201 as shown in FIG. 3B, with a frame number one size smaller than the hypoid speed reducer 1, as a hypoid gear set 204, a first parallel gear set (second-stage gear set) 205 connected to the hypoid gear set 204, and a first intermediate shaft (rotating shaft) 211 on which a spur gear 216 of the hypoid gear set 204 and a spur gear (pinion) 217 of the first parallel gear set 205 are provided. Here, the term “frame number” is used to define a size of torque handled by these speed reducers. For example, when it is said that “a speed reducer has a frame number one size smaller,” it means that the output shaft of the device has a shaft diameter one size smaller. Generally, a plurality of speed reducers for a plurality of reduction ratios are prepared using output shafts of a same frame number.

The second intermediate shaft 12 and the spur gears 19 and 20 constituting the second parallel gear set 6 of the hypoid speed reducer 1 are also used in common in the three-stage speed reducer 201 as a second intermediate shaft 212 and spur gears 219 and 220 constituting a second parallel gear set 206, respectively.

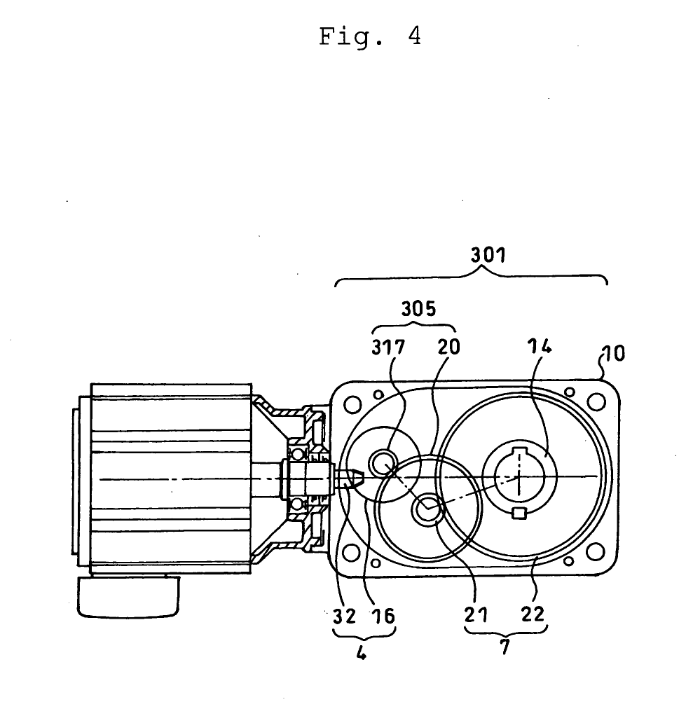

FIG. 4 shows a hypoid speed reducer 301 in which the hypoid gear set (first-stage gear set) 4, a middle-stage gear set 305 constituted by a spur gear 317 and the spur gear 20, and the third parallel gear set (final-stage gear set) 7 are linked to one another and accommodated in the same gear box 10 as used for the hypoid speed reducer 1. In this hypoid speed reducer 301, a spur gear 317 capable of mating with the gear 20 of the second parallel gear set (third-stage gear set) 6 is employed instead of the spur gear 17 of the first parallel gear set (second-stage gear set) 5 of the hypoid speed reducer 1.

The hypoid speed reducer 301 is designed such that speed can be reduced in three stages, firstly by the hypoid gear set 4 (gears 32 and 16), then by the middle-stage gear set 305 (gears 317 and 20) and then by the third parallel gear set 7 (gears 21 and 22), and the reduced speed is outputted to the output shaft 14.

With the hypoid speed reducer 1 according to the embodiment of the invention, the four gear sets 4 through 7 including the hypoid gear set 4 as the first-stage gear set are all accommodated in the single gear box 10, which makes it possible to provide a high reduction ratio exceeding-about 240:1 and, at the same time, to reduce noise of the entire hypoid speed reducer 1. Generally, when the hypoid speed reducer 1 is combined with the motor 3, the first-stage gear set is driven at the highest speed among the gear sets and tends to make noise when being driven. However, according to the invention, such noise problem can be solved by employing the hypoid gear set 4 capable of reducing noise as the first-stage gear set. Further, in comparison with a conventional hypoid speed reducer having a parallel gear set added to provide a high reduction ratio, the hypoid speed reducer 1 of the present invention allows for providing reduced costs and improved productivity. Furthermore, the present invention enables the device to be made in a smaller size and to be installed easily.

The second and third intermediate shafts 12 and 13 are arranged to be present on the plane P1 that is orthogonal to the center L1 of the motor shaft (pinion shaft) 31, which makes it possible to reduce the dimensions of the hypoid speed reducer 1 (particularly, in the direction of the center L1 of the motor shaft 31). It should be noted that the center L1 of the motor shaft 31 is not necessarily exactly orthogonal to the plane P1 but may intersect with the plane P1 at an angle in the range of 90 degrees +/−10%.

Further, the output shaft 14 is arranged to be orthogonal to the center of the motor shaft (pinion shaft) 31, which makes it possible to reduce further the dimensions of the device (particularly, in the radial direction of the motor shaft 31).

The connecting dimensions of the mounting face F1 (F2) of the hypoid speed reducer 1 are designed to be the same as dimensions of connection with driven device of the two-stage or three-stage hypoid speed reducer prepared as a component of the group. Therefore, the hypoid speed reducer 1 can be applied to a driven device easily and a wide variety of reduction ratios can be provided according to users' needs.

Further, according to the invention, the third parallel gear set (final-stage gear set) 7, third intermediate shaft (rotating shaft) 13 on which the spur gear (pinion) 21 and the spur gear 22 constituting the third parallel gear set 7 are provided, and the output shaft (rotating shaft) 14 of the hypoid speed reducer 1 are used in common as the respective corresponding members in the two-stage hypoid speed reducer 101. Furthermore, the hypoid gear set 4, the first parallel gear set 5 linked to the hypoid gear set 4, the first intermediate shaft (rotating shaft ) 11 on which the spur gear 16 of the hypoid gear set 4 and the spur gear (pinion) 17 of the first parallel gear set 5 are provided are also used in common as the respective corresponding members in the three-stage hypoid speed reducer 201 with a frame number one size smaller than that of the hypoid speed reducer 1.

Accordingly, most of the members (rotating shafts, gears, bearings, etc.) constituting the hypoid speed reducer 1 can be obtained from other types of hypoid speed reducers, which enables the hypoid speed reducer 1 to be manufactured at reduced costs and to be developed in a shortened period of time. If hypoid speed reducers using these members in common are provided as a group, the constituent members can be shared among the devices within the group, which also makes it possible to lower the production costs and to shorten the period of time required for development of hypoid speed reducers.

If the hypoid speed reducer 301 comprising the hypoid gear set 4 (gears 32 and 16), the middle-stage gear set 305 (gears 317 and 20) and the third parallel gear set 7 (gears 21 and 22) is employed instead of the hypoid speed reducer 1, speed reduction can be performed in three stages. Thus a user is allowed to select an appropriate reduction mode between three-stage and four-stage reduction modes according to his/her intended use. Furthermore, since various members including the gear box 10 can be shared between the speed reducers, it is easy to change over from the three-step reduction mode to the four-step reduction mode or vice versa.

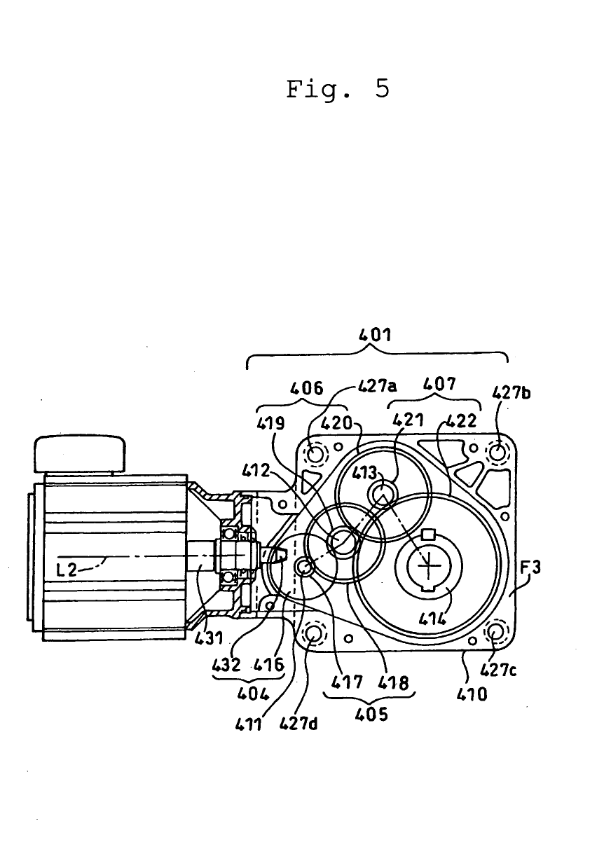

In the embodiment as described above, the hypoid speed reducer 1 is constituted by the hypoid gear set 4 and the three parallel gear sets 5 through 7. It will be understood that the present invention is not limited to such constitution, but can be embodied as any four-stage hypoid speed reducer so far as four gear sets including a hypoid gear set as the first-stage gear set can be accommodated in a single gear box. Further, arrangement of the four gear sets 4 through 7 is not limited to the arrangement as shown in the drawings, but the present invention may be embodied as a hypoid speed reducer 401 having four gear sets 404 through 407 as shown in FIG. 5, for example.

This hypoid speed reducer 401 is similar to the hypoid speed reducer 1 in terms of having four gear sets comprising a hypoid gear set 404 and first to third parallel gear sets 405 through 407, but is different in terms of the arrangement of first to third intermediate shafts 411 through 413 and an output shaft 414. The four gear sets 404 through 407 are accommodated in a gear box 410 having mounting holes 427a through 427d formed at positions corresponding to the apexes of a square. The arrangement of the mounting holes 427a through 427d of the gear box 410 at the positions corresponding to the apexes of a square will enable the hypoid speed reducer 401 to be arranged horizontally or orthogonally with respect to a counterpart device (driven device) according to situations where the device is installed.

Similarly to the hypoid speed reducer 1 described above, the hypoid speed reducer 401 also shares members with a two-stage or three-stage speed reducer, which makes it possible to reduce costs and shorten the delivery schedule.

In the description of the embodiment above, an example has been shown in which the third parallel gear set 7 and the third intermediate shaft 13 on which the spur gears 21 and 22 constituting the third parallel gear set 7 are provided, and the output shaft 14 of the hypoid speed reducer 1 are used in common as the respective corresponding members in the two-stage hypoid speed reducer 101. It will be appreciated, however, that those members also can be shared with a three-stage hypoid speed reducer. In fact, the four-stage hypoid speed reducer 1 and the two-stage or three-stage hypoid speed reducer have only to share part of the gear sets or rotating shafts.

According to the present invention, it is possible to provide a hypoid speed reducer and a group of such devices capable of providing a high reduction ratio and still capable of reducing noise, lowering costs, enabling size reduction, and improving productivity.

The disclosure of Japanese Patent Application No. 2002-370668 filed Dec. 20, 2002 including specification, drawings and claims is incorporated herein by reference in its entirety.

What is claimed is:

1. A hypoid speed reducer, comprising
a hypoid gear set having a hypoid pinion and a hypoid gear, and
a single gear box being able to accommodate four gear sets including the hypoid gear set, wherein
three or four gear sets including the hypoid gear set as a first-stage gear set are accommodated in the single gear box.

2. The hypoid speed reducer according to claim 1, wherein
the hypoid speed reducer is contructed as a four-stage hypoid speed reducer having four gear sets in the single gear box, and the four-stage hypoid speed reducer has a first intermediate shaft having the hypoid gear provided thereon, a second intermediate shaft linked to the first intermediate shaft via a second-stage gear set, and a third intermediate shaft linked to the second intermediate shaft via a third-stage gear set, and
the second and third intermediate shafts are arranged in a same plane intersecting orthogonally with the center of a pinion shaft having the hypoid pinion formed thereon.

3. The hypoid speed reducer according to claim 1, wherein
an output shaft of the hypoid speed reducer is arranged so as to be orthogonal to the center of a pinion shaft having the hypoid pinion formed thereon.

4. The hypoid speed reducer according to claim 1, wherein
the hypoid speed reducer is constructed as a four-stage hypoid speed reducer having four gear sets in the single gear box, and the four-stage hypoid speed reducer has a first intermediate shaft having the hypoid gear provided thereon, a second intermediate shaft linked to the first intermediate shaft via a second-stage gear set, and a third intermediate shaft linked to the second intermediate shaft via a third-stage gear set, and
the second and third intermediate shafts are arranged in a same plane intersecting orthogonally with the center of a pinion shaft having the hypoid pinion formed thereon and an output shaft of the four-stage hypoid speed reducer is arranged so as to be orthogonal to the center of the pinion shaft having the hypoid pinion formed thereon.

5. The hypoid speed reducer according to claim 1, wherein
the hypoid speed reducer is constructed as a three-stage hypoid speed reducer having three gear sets in the single gear box, and three-stage speed reduction can be performed by the first-stage gear set, a middle-stage gear set, and a final-stage gear set, and wherein
the middle-stage gear set comprise a pinion of a second-stage gear set of a four stage speed reducer, and a gear of a third-stage gear set of the four stage speed reducer.

6. A group of hypoid speed reducers, comprising
a four-stage hypoid speed reducer having four gear sets comprising at least a hypoid gear set comprising a hypoid pinion and a hypoid gear, as a first-stage gear set, the four gear sets being accommodated in a single gear box, and
a two-stage or three-stage hypoid speed reducer having a hypoid gear set and one or two parallel gear set(s) linked to the hypoid gear set, wherein
the four-stage hypoid speed reducer has identical dimensions of connection with a driven device to those of the two-stage or three-stage hypoid speed reducer.

7. A group of hypoid speed reducers, comprising
a four-stage hypoid speed reducer having four gear sets comprising at least a hypoid gear set comprising a hypoid pinion and a hypoid gear, as a first-stage gear set, the four gear sets being accommodated in a single gear box, and
a two-stage or three-stage hypoid speed reducer having a hypoid gear set and one or two parallel gear set(s) linked to the hypoid gear set, wherein
each of the hypoid speed reducers constituting the group has at least a part of the gear sets or rotating shafts thereof used in common with another hypoid speed reducer in the group.

8. The group of hypoid speed reducers according to claim 7, wherein the hypoid speed reducers constituting the group use in common with a final-stage gear set and a rotating shaft on which a pinion or a gear constituting the final-stage gear set is provided.

9. A group of hypoid speed reducers, comprising
a four-stage hypoid speed reducer having four gear sets comprising at least a hypoid gear set comprising a hypoid pinion and a hypoid gear, as a first-stage gear set, the four gear sets being accommodated in a single gear box, and
a three-stage hypoid speed reducer with a frame number one size smaller than the four-stage hypoid speed reducer when a magnitude of torque handled by the speed reducer is defined by a frame number, wherein
the hypoid gear set, a second-stage gear set linked to the hypoid gear set, and a rotating shaft having a gear of the hypoid gear set and a pinion of the second-stage gear set formed thereon of the four-stage hypoid speed reducer are used in common by the three-stage hypoid speed reducer respectively as a hypoid gear set, a second-stage gear set linked to the hypoid gear set, and a rotating shaft having a gear of the hypoid gear set and a pinion of the second-stage gear set formed thereon.
